(19) United States
(12) Patent Application Publication
(10) Pub. No.: US 2025/0252373 A1
(43) Pub. Date: Aug. 7, 2025

(54) SYSTEM AND METHOD FOR MANAGING ASSET ALLOCATION FOR AN EVENT

(71) Applicant: JUGL INC., Frisco, TX (US)

(72) Inventors: Arun Kumar Ponnusamy, Frisco, TX (US); Arun Prasad Jaganathan, Prosper, TX (US)

(21) Appl. No.: 18/434,890

(22) Filed: Feb. 7, 2024

(51) Int. Cl. G06Q 10/0631

(52) U.S. Cl. CPC G06Q 10/06315

(57) ABSTRACT

A method for managing budget allocation for an event is described. The method comprises obtaining data pertaining to the event from a vendee. The event is allocated to a vendor for completion of tasks associated with the event. The data is analyzed to define a scope of the event. An overall budget is evaluated for the event based on the scope of the event. The overall budget is divided into multiple sub-budgets. A sub-budget from the multiple sub-budgets is allocated to a corresponding task of the one or more tasks based on the division of the overall budget. A notification is transmitted to devices associated with the vendor and the vendee. The notification indicates the budget allocated for the corresponding task.

### FIELD OF THE INVENTION

The present invention relates to the field of event management, and particularly to an artificial-intelligence (AI) based event management for coordinating between vendors and vendees.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

When an entity, such as a business, academic, government or other organization undertakes a large project or event, it is desirable to have a system to manage information about the project or event. For example, it may be desirable to accumulate schedules, costs, and other information related to the project or event and to manage payments for ongoing projects with a service provider, such as a vendor.

Although some project management systems are available, existing packages are limited in scope and flexibility. For example, conventional systems require the entity (vendee) to make complete payments either in advance or upon completion of the project or event. Such practice is not suitable for dynamic nature of project or event development.

As explained heretofore, conventional project management systems provide inflexible payment framework that leads to client dissatisfaction. Thus, there is a need an adaptive and transparent project management technique, which overcomes shortcomings of conventional techniques.

### SUMMARY OF THE INVENTION

The present invention relates to a system for managing computing network. The objective of the invention is to overcome the limitations of conventional techniques of managing budget allocation for an event.

According to an embodiment of the present disclosure, a method for managing budget allocation for an event is described. The method comprises obtaining data pertaining to the event from a vendee. The event is allocated to a vendor for completion of tasks associated with the event. The data is analyzed to define a scope of the event that indicates factors that affect completion of each task of the one or more tasks associated with the event. An overall budget is evaluated for the event based on the scope of the event. The overall budget is divided into multiple sub-budgets based on one of information related to a budget allocation for a relevant event similar to the event allocated to the vendor when the relevant event is previously accomplished, a requirement of the one or more tasks to be performed for completion of the event when the event is newly introduced by the vendee; and at least one parameter associated with a location of the event and a type of the one or more tasks to be performed for completing the event when the event is associated with a new vendee. A sub-budget from the multiple sub-budgets is allocated to a corresponding task of the one or more tasks based on the division of the overall budget. A notification is transmitted to devices associated with the vendor and the vendee. The notification indicates the budget allocated for the corresponding task

In an aspect, the event is one of an operational event, a business event, a construction event, and a manufacturing event.

In an aspect, the data pertaining to the event comprises at least one of a start date of the event, a time period allotted to the event, constraints related to the event, and a difficulty level of the event.

In an aspect, the event is divided into the one or more tasks based on a pattern of the relevant event when the event is previously accomplished or a type of the event when the event is newly introduced by the vendee.

In an aspect, the method further comprises monitoring, by the ML module, progression of the event to determine completion of each task of the plurality of tasks and transmitting, by the communication module, a request for releasing the sub-budget allocated for the task based on the determination the completion of the corresponding task.

In an aspect, the method further comprises receiving, by the data processing engine, an indication to make changes in at least one task of the one or more tasks associated with the event, evaluating, by the ML module, a change in a portion of the sub-budget allocated for corresponding task based on the indication, and modifying, by the ML module, allocation of the sub-budget to the corresponding task, based on the evaluation of the change in the portion of the sub-budget.

In an aspect, the method further comprises monitoring, by the ML module, a status of releasing the sub-budget for a corresponding task, determining, by the ML module, whether the sub-budget is released by the vendee after completion of the corresponding sub-event, and transmitting, by the communication module to the one or more devices associated with the vendor, an indication to stop operation of other tasks based on the determination that the sub-budget is pending by the vendee.

In an aspect, the method further comprises receiving, by the data processing engine, a signal indicating completion of a task of the event, transmitting, by the communication module, a request for feedback related to quality of work towards the task based on the signal, receiving, by the communication module, the feedback related to the quality of the work through a graphical user interface (GUI) associate with the data processing engine, and forwarding, by the communication module, the feedback to the one or more devices associated with the vendor.

According to an embodiment of the present disclosure, a system for managing budget allocation for an event is disclosed. The system comprises one or more data processing engines and a memory comprising instructions which, when executed on the one or more data processing engines, cause the one or more data processing engines to obtain data pertaining to the event from a vendee. The event is allocated to a vendor for completion of tasks associated with the event. The data is analyzed to define a scope of the event that indicates factors that affect completion of each task of the one or more tasks associated with the event. An overall budget is evaluated for the event based on the scope of the event. The overall budget is divided into multiple sub-budgets based on one of information related to a budget allocation for a relevant event similar to the event allocated to the vendor when the relevant event is previously accomplished, a requirement of the one or more tasks to be performed for completion of the event when the event is newly introduced by the vendee; and at least one parameter associated with a location of the event and a type of the one or more tasks to be performed for completing the event when the event is associated with a new vendee. A sub-budget from the multiple sub-budgets is allocated to a corresponding task of the one or more tasks based on the division of the overall budget. A notification is transmitted to devices associated with the vendor and the vendee. The notification indicates the budget allocated for the corresponding task.

According to an embodiment of the present disclosure, a non-transitory computer readable medium for managing asset allocation for an event is disclosed. The non-transitory computer readable medium comprises instructions configured to cause one or more data processors to obtain data pertaining to the event from a vendee. The event is allocated to a vendor for completion of tasks associated with the event. The data is analyzed to define a scope of the event that indicates factors that affect completion of each task of the one or more tasks associated with the event. An overall budget is evaluated for the event based on the scope of the event. The overall budget is divided into multiple sub-budgets based on one of information related to a budget allocation for a relevant event similar to the event allocated to the vendor when the relevant event is previously accomplished, a requirement of the one or more tasks to be performed for completion of the event when the event is newly introduced by the vendee; and at least one parameter associated with a location of the event and a type of the one or more tasks to be performed for completing the event when the event is associated with a new vendee. A sub-budget from the multiple sub-budgets is allocated to a corresponding task of the one or more tasks based on the division of the overall budget. A notification is transmitted to devices associated with the vendor and the vendee. The notification indicates the budget allocated for the corresponding task.

### BRIEF DESCRIPTION OF DRAWINGS

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a simplified diagram of a computing environment, in accordance with an embodiment of the present invention;

FIG. 2 illustrates an exemplary event, in accordance with an embodiment of the present invention;

FIG. 3 illustrates a simplified diagram of the data processing engine, in accordance with an embodiment of present invention;

FIG. 4 illustrates a block diagram of the ML model, according to an embodiment of the present invention;

FIGS. 5 and 6 illustrate a user interface, according to an embodiment of the present invention;

FIG. 7 illustrates a flow chart of a method for managing asset allocation for the event, according to an embodiment of the present invention;

FIG. 8 illustrates an example of a computer system, according to an embodiment of the present invention; and

FIG. 9 illustrates a block diagram of an example of a computing environment, according to an embodiment of the present invention.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

The term “some” as used herein is to be understood as “none or one or more than one or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments, without departing from the scope of the present disclosure.

The terminology and structure employed herein is for describing, teaching, and illuminating some embodiments and their specific features. It does not in any way limit, restrict or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not be necessarily taken as limiting factors to the attached claims. The attached claims and their legal equivalents can be realized in the context of embodiments other than the ones used as illustrative examples in the description below. Embodiments of the present invention will be described below in detail with reference to the accompanying drawings.

One or more embodiments of the present invention provide a method and a system for managing budget allocation for an event. The event may be an operational event, a business event, a construction event, or a manufacturing event. For example, the event may be a project for construction of a building. A vendee of the event may allocate the event to a vendor for completion of one or more tasks associated with the event. The system may obtain data pertaining to the event from the vendee. The data pertaining to the event may comprise, but is not limited to, a start date of the event, a time period allotted to the event, constraints related to the event, and a difficulty level of the event. The system may analyze the data pertaining to the event to define a scope of the event. The scope of the event may indicate factors that affect completion of each task of the one or more tasks associated with the event, such as a time duration of completion of the one or more tasks associated with the event, cost of raw materials utilized in the event, an insurance related to the event, and a number of workers required for completion of the one or more tasks associated with the event.

The system may evaluate an overall budget for the event based on the scope of the event. In some embodiments, the overall budget is evaluated based on allocated overall budget for the previously accomplished events. The system may further divide the overall budget into a plurality of sub-budgets. The division of the budget may be performed based on information related to a budget allocation for a relevant event similar to the event allocated to the vendor when the relevant event is previously accomplished, a requirement of the one or more tasks to be performed for completion of the event when the event is newly introduced by the vendee and at least one parameter associated with a location of the event and a type of the one or more tasks to be performed for completing the event when the event is associated with a new vendee.

Further, the system transmits a notification to devices associated with the vendor and/or the vendee. The vendor and the vendee may take further actions based on the notification. For example, the vendor may plan which sub-event of the multiple sub-events could be initiated.

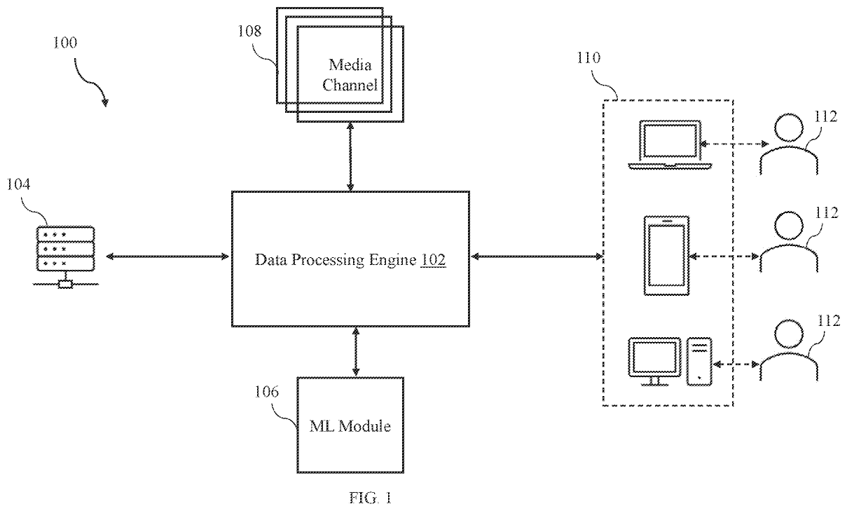

FIG. 1 illustrates a simplified diagram of a computing environment 100, in accordance with an embodiment of the present invention. The computing environment 100 comprises various computing systems (e.g., servers and devices) interconnected by a wireless or wired network (not illustrated). The network may comprise any combination of a wide area network (e.g. WAN), local area network (e.g. LAN), cellular network, wireless LAN (e.g. WLAN), or any such means for enabling communication of computing systems. The network may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks.

The computing environment 100 may comprise a data processing engine 102 that obtains data pertaining to an event from a vendee. The event may be allocated to a vendor for completion of one or more tasks associated with the event. The vendee may provide all the information related to the event to a client server 104. The client server 104 may be implicitly or explicitly associated with the vendee. The client server 104 may store all information associated with an organization owned by the vendee. The information associated with the organization may comprise types of the task to be performed by the employee(s) of the organization along with historical data of the client's accomplished events. The client server 104 may also store information related to relevant events similar to the event allocated to the vendor.

The data processing engine 102 may represent any single computing system with dedicated hardware and software, multiple computing systems clustered together (e.g., a server farm), a portion of shared resources on one or more computing systems (e.g., virtual server), or any combination thereof.

The data processing engine 102 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The data processing engine 102 can include one or more virtual machines running virtual operating systems, or other computing architectures involving virtualization such as one or more flexible pools of logical storage devices that can be virtualized to maintain virtual storage devices for the server. In various embodiments, the data processing engine 102 may be adapted to run one or more services or software applications that provide the functionality described in the foregoing disclosure.

The computing systems in the data processing engine 102 may run one or more operating systems including any of those discussed above, as well as any commercially available server operating system. The data processing engine 102 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

The data processing engine 102 may obtain the data pertaining to the event from the client server 104. The data pertaining to the event comprises a start date of the event, a time period allotted to the event, constraints related to the event, and a difficulty level of the event. The data processing engine 102 may analyze the data pertaining to the event to define a scope of the event. In some embodiments, the scope of the event may indicate factors that affect completion of each task of the one or more tasks associated with the event, such as a time duration of completion of the one or more tasks associated with the event, cost of raw materials utilized in the event, an insurance related to the event, and a number of workers required for completion of the one or more tasks associated with the event.

The data processing engine 102 may divide the event into multiple sub-events based on the scope of the event. In subsequent paragraphs, a sub-event is also interchangeably referred to as a task. For example, the project of construction of the building may be divided into a task associated with design phase, a task associated with pre-construction phases, a task associated with procurement phase, a task associated with construction phase, and a task associated with post-construction/closeout phase.

The post processing engine 102 utilizes a machine learning (ML) module 106 for division of the event into multiple tasks. The ML module 106 may be trained on training dataset to segregate the one or more tasks associated with the event into multiple tasks. In some embodiments, the ML module 106 may divide the event into multiple tasks based on various parameters. For example, the ML module 106 may receive information related to relevant events that are previously accomplished by the vendee. The information related to the relevant events may be received from various media sources 108. Examples of the media source 108 may include, but are not limited to, an external server that stores all the information related to events and an internal source that stores information related to events accomplished by the vendee. Based on the information related to the relevant events, the ML module 106 may divide the events into multiple tasks. For example, if a relevant event is previously accomplished by the vendee, the ML module 106 may extract details of the tasks of that the relevant event and may divide the event into multiple sub-event in same fashion the tasks are the relevant event was divided.

In some other embodiments, when a new event is allocated by a new vendee, the ML module 106 may analyze the event using Natural Language Processing (NLP) protocols to determine a type of actions to be taken for accomplishing the event. Further, the ML module 106 may divide the event into multiple tasks based on the type of actions to be taken for accomplishing the event.

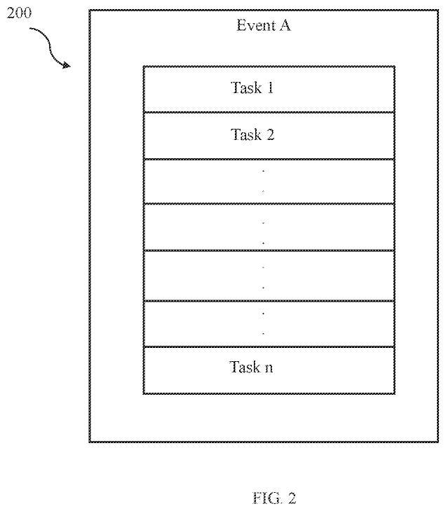

FIG. 2 illustrates an exemplary event 200, in accordance with an embodiment of the present invention. As illustrated in FIG. 2, an event A is divided into multiple tasks, such as task 1, task 2, so on till task n. It should be noted that FIG. 2 illustrates an exemplary scenario of division of an event, in practical scenarios the event may be divided into any number of tasks.

The data processing engine 102 may utilize the ML module 106 to evaluate an overall budget for the event based on the scope of the event. The overall budget is an amount to be given to the vendor for completing the event. In some embodiments, the overall budget may be allotted by the vendee. In some other embodiments, the overall budget may be determined by the ML module 106 based on overall budget allotted for the relevant events.

The ML module 106 may divide the overall budget into multiple sub-budgets based on various parameters, such as information related to a budget allocation for a relevant event similar to the event allocated to the vendor when the relevant event is previously accomplished, a requirement of the one or more tasks to be performed for completion of the event when the event is newly introduced by the vendee and at least one parameter associated with a location of the event and a type of the one or more tasks to be performed for completing the event when the event is associated with a new vendee.

Further, the ML module 106 may allocate a sub-budget from the plurality of sub-budgets to a corresponding task of the multiple tasks. The overall budget may be divided into multiple phases for multiple sub-events. In the first case, the event allocated to the vendor is similar to a relevant event previously accomplished by the same vendee or by other vendees. In such a case, the ML module 106 may obtain a pattern of phase wise payments used for the relevant event. The pattern may be obtained by multiple media sources. Further, the ML module 106 may allocate a portion of the overall budget to the corresponding sub-event according to the pattern of phase wise payments used for the relevant event.

In the second case, the vendee allocates a new event that is not accomplished previously by the vendee. In such a case, the ML module 106 may obtain data from various media channels 108 (databases) related to the actions to be performed for accomplishing the event. The ML module 106 may further allocate budget in accordance with requirement of the actions to be performed for accomplishing the event. The media channels 108 may be any server which stores data related to any event. For example, a server associated with a government tender.

In the third case, a new vendee allocates the event to the vendor. In such a case, the ML module 106 is not able to obtain information related to previously accomplished events. Thus, the ML module 106 may obtain multiple parameters, such as location of the vendee and a type of actions to be performed for accomplishing the event. Based on such parameters, the ML module 106 may allocate the portion of the overall budget to the corresponding sub-event of the multiple sub-events.

The data processing engine 102 may transmit a notification to devices 110 associated with the vendor and vendee 112. In some embodiments, the devices 110 may represent one of a variety of other computing devices (e.g., a laptop computer 104a, a smart phone 104b, a desktop computer 104c, an IP phone, a tablet, etc.) having hardware and software (e.g. web browser application) capable of processing and displaying information (e.g., web page, graphical user interface, etc.), and communicating information (e.g., web page request, user activity, campaign settings, etc.) over the network.

The device 110 may include various types of computing systems such as PA devices, portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

In some embodiments, the data processing engine 102 may notify the vendee regarding the multiple tasks of the event and the portion of overall budget corresponding to the sub-event. The vendee may be required to make the payment for initialization of the event and a notification is sent to the device 110 associated with the vendee related to make the payment upon completion of a task of the event.

In some embodiments, the vendor may be enabled to real-time monitoring of the progression of the event through various notifications. In case the vendee wants to amend a particular task of the event, the ML module accordingly may evaluate the change in cost of the particular task of the event in accordance with amendment required by the vendee. Further, the data processing engine may notify the vendee regarding change in cost and also reallocate the phase wise budget.

In some embodiments, the data processing engine 102 may notify a concerned authority regarding status of the payment at the time of completion of a particular task of the event. In case the vendee has not made the payment, the data processing engine 102 may send a notification to the vendee for making the payment immediately or may report a problem which is considered by the concerned authority.

In some embodiments, if the vendee has not reported any complaint, the data processing engine 102 may transmit a notification to the particular employees working on the specific task related to not proceed further until the vendee makes the payment.

In some embodiments, the data processing engine 102 may notify the vendee and the concerned authority regarding completion of the event and may enable the vendee to provide feedback by entering inputs over a user interface installed over the device 110 associated with the vendee.

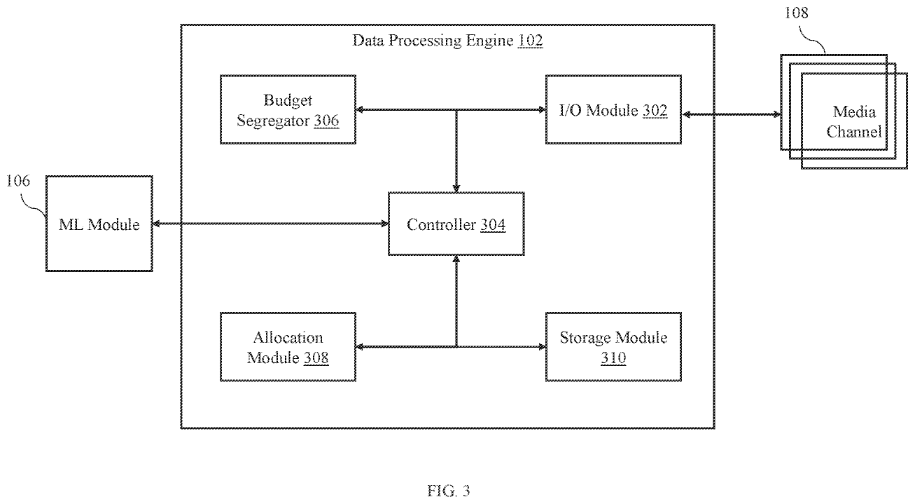

FIG. 3 illustrates a simplified diagram of the data processing engine 102, in accordance with an embodiment of present invention. The data processing engine 102 may comprise an Input/Output (I/O) module 302, a controller 304, a budget segregator 306, an allocation module 308, and a storage module 310. It should be understood that all the modules of the data processing engine 102 are communicatively coupled with each other.

The I/O module 302 may obtain the data pertaining to the event from the vendee. The event may be allocated to the vendor for completion of one or more tasks associated with the event. Further, the I/O module 302 is communicatively coupled with the media channels 108 for obtaining the information related to relevant events similar to the event allocated to the vendor.

The controller 304 may acquire above-mentioned data from the I/O module 302 and may analyze the data for further processing. In some embodiments, the controller 304 may determine the scope of the event based on the data. Further, the controller 304 may evaluate the overall budget for the event. The overall budget may be evaluated based on the scope of the event. The overall budget is an amount to be given to the vendor for completing the event.

The budget segregator 306 may divide the overall budget into multiple sub-budgets based on various parameters. For example, the overall budget of construction of the building may be divided into a sub-budget associated with a design phase, a sub-budget associated with a pre-construction phase, a sub-budget associated with procurement phase, a sub-budget associated with a construction phase, and a sub-budget associated with a post-construction/closeout phase. In some embodiments, the budget segregator 306 may utilize the ML module 106 for dividing the event into multiple sub-budget.

In an embodiment, the overall budget may be divided into multiple sub-budgets based on information related to a budget allocation for a relevant event similar to the event allocated to the vendor when the relevant event is previously accomplished. In another embodiment, the overall budget may be divided into multiple sub-budgets based on a requirement of the one or more tasks to be performed for completion of the event when the event is newly introduced by the vendee. In yet another embodiment, the overall budget may be divided into multiple sub-budgets based on at least one parameter associated with a location of the event and a type of the one or more tasks to be performed for completing the event when the event is associated with a new vendee.

The controller 306 may utilize the ML module 106 to allocate a sub-budget from the plurality of sub-budgets to a corresponding task of the one or more tasks based on the division of the overall budget. For example, a first portion of the overall budget may be allocated a design phase, a second portion of the overall budget may be allocated to a pre-construction phase, a third portion of the overall budget may be allocated to a procurement phase, a fourth portion of the overall budget may be allocated to a construction phase, and a fifth portion of the overall budget may be allocated to a post-construction/closeout phase.

The storage module 310 may store all the relevant data temporarily or permanently for the purpose of processing. For example, the storage module 310 may store training data and testing data associated with the ML module 106. In addition, the storage module 310 may store program instruction to be executed by the controller 304.

The storage module 310 may include one or more non-transitory memory devices, including volatile and non-volatile memory devices. The storage module 310 is shown to be depicting, the system memory and the computer-readable storage media. The storage module 310 may include a number of memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system, such as during start-up, may typically be stored in the ROM. The RAM typically contains data and/or program modules that are presently being operated and executed by processing subsystem. In some implementations, the storage module 310 may include multiple different types of memory, such as static random-access memory (SRAM), dynamic random-access memory (DRAM), and the like.

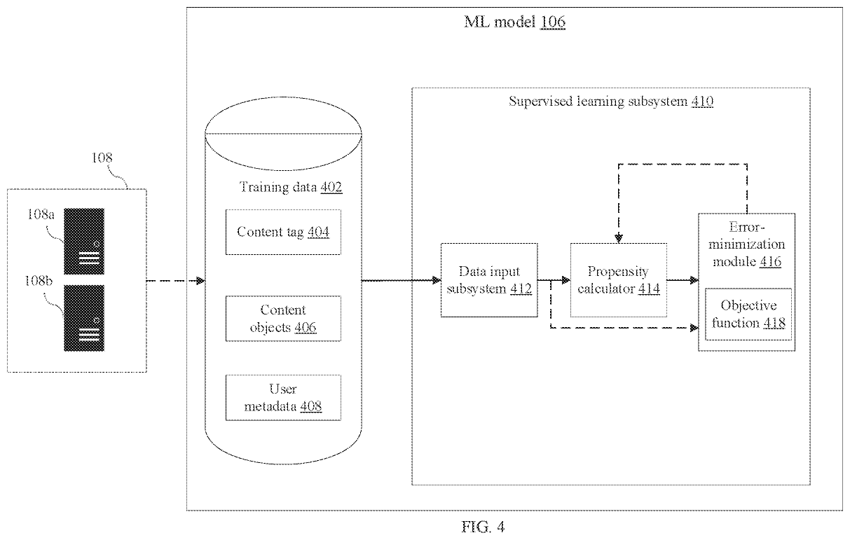

FIG. 4 illustrates a block diagram of the ML model 106, according to an embodiment of the present invention. More specifically, in some embodiments, The ML model 106 may be trained using training data 402. The training data 402 may be populated by data received from the multiple media sources 108, such as an external database 108a and an internal database 108b. The ML model 106 may be or include a non-binary classifier, such as a multinomial logistic regression model implemented in a neural network, trained to predict a probability that an input can be mapped to one or more classes of a set of classes, corresponding to content tags 404 or user characteristics from user metadata 408. As such, training the ML model 106 may include applying a supervised learning technique using one or more labeled sets of training data 402, which may include content tags 404, content objects 406, and user metadata 408. The user metadata 408 may include data related to the vendee and/or the vendor. The content objects 406 may comprise data related to all the events accomplished by the vendee. The content tags 404 may be drawn from a database of features that the feature prediction models are trained to identify. As such, the content tags 404 may correspond to the features that may characterize content objects processed by the ML model 106.

The training data may be provided to a supervised learning subsystem 410. For example, the supervised learning subsystem 410 may comprise a data input subsystem 412 to receive the training data 402. As part of supervised training, the supervised learning subsystem 410 may use the training data 402 to define a ground truth, such that elements defining a mapping of the content tags 404 and user characteristics from the user metadata 408 are provided to a propensity calculator 414 and an error minimization module 416. The error minimization module 416 may, in turn, implement an objective function 418, which may be an error function, for example, defined as a distance between the model output and the ground truth. In this way, training may include adjusting one or more weights and/or coefficients of the propensity calculator 414 over multiple iterations until the value of the objective function converges to a global minimum.

In some embodiments, the input to the propensity calculator 414 includes the characteristics of a set of users, and the output includes a vector of probability values corresponding to predicted content features. In this way, the propensity calculator 414 may be trained to map the content tags 404 of the training data 402 to the user metadata 408 of the training data 402, and, once trained, the propensity calculator 414 may be used to generate the propensity score. As trained, the propensity calculator may be able to determine the propensity score indicative of the extent to which the user has propensity for releasing user's data to at least one digital platform.

In some embodiments, the supervised learning subsystem 410 may implement hyperparametric tuning, in addition to supervised learning, to optimize the ML model 106. For example, one or more terms of the objective function 418 and/or the ML model 106 may be fine-tuned by varying parameters that are not learned, such as scalar weighting factors.

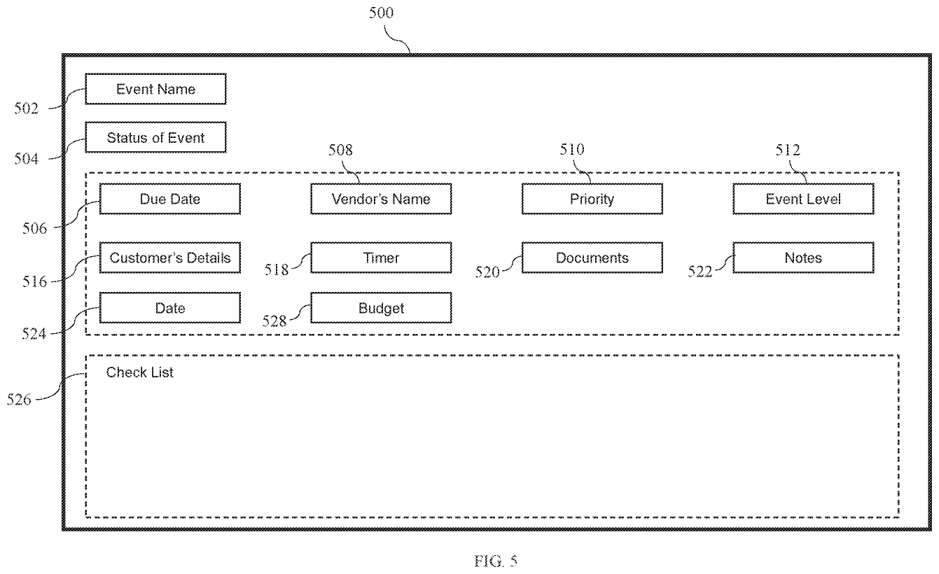

FIG. 5 illustrates a user interface 500, according to an embodiment of the present invention. The user interface 500 may be displayed on the user device associated with the vendee and/or the vendor. The user interface 500 may include multiple elements indicating distinct items. For example, as illustrated in FIG. 5, the user interface 500 includes an element, 502, an element 504, an element 506, an element 508, an element 510, an element 512, an element 514, an element 516, an element 518, an element 520, an element 522, an element 524, and an element 526.

The element 502 may indicate a name of the event. For example, the name of the event may be “Building a Car Factory”. The element 504 may indicate a status of the event. For example, the status of the event may be one of, completed, pending, active, suspended, etc. The status of the event may be updated dynamically based on completion of the tasks associated with the event.

The element 506 may indicate a due date of the event. The due date may be one of a tentative date for completion of the event, a client commented deadline of the event, a statutory deadline assigned by a third party, etc. The element 508 may indicate name of a vendor. The event may be assigned to the vendor. The vendor may be an employee of the organization, a third-party organization, etc. The element 510 may indicate a priority of the event. The element 512 may indicate a level of the event. For example, the level of the event may include an easy level, a hard level, and a medium level.

The element 516 may indicate details of a customer associated with the event. In an example, the customer may be client of an organization. The element 518 may indicate a timer associated with the progress of the event. The timer may be synchronized with the event and may be dynamically updated during the progress of the event. The element 520 may comprise documents related to the event. For example, the documents comprise, but are not limited to, a contract executed between the vendor and the vendee. The notes may comprise additional notes provided by the vendor and/or the vendee.

The element 524 may indicate a current date. The element 526 may indicate a check list related to the event. The check list may include all related details updated by the vendor and/or the vendee. For example, the vendor and/or the vendee may update all the information dynamically.

The element 528 may indicate an overall budget of the event. The overall budget may be assigned based on the scope of the event. The overall budget is an amount to be given to the vendor for completing the event. The element 528 may enable a user to view allocated budget for each task associated with the event.

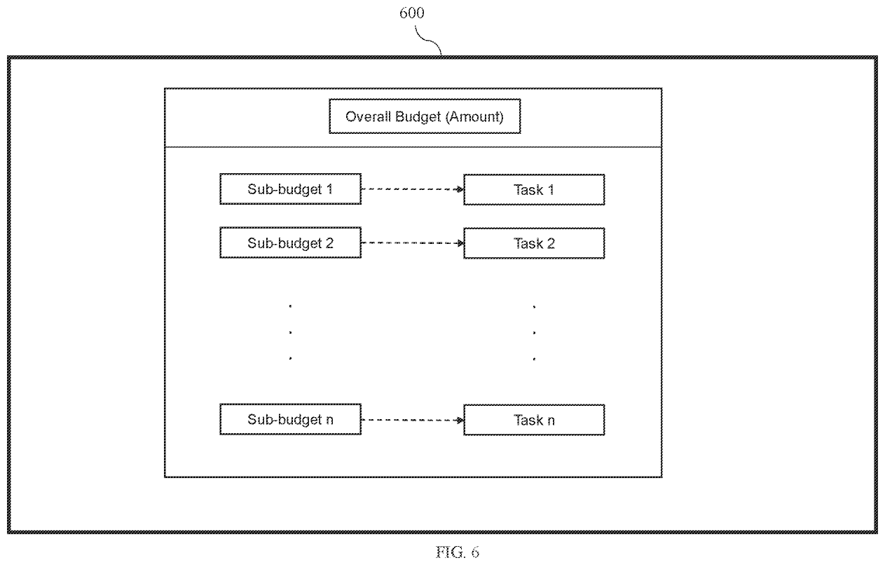

FIG. 6 illustrates a user interface 600, according to an embodiment of the present invention. When a user, such as the vendor and/or the vendee clicks on the element 528, illustrated in FIG. 5, the user interface 600 may be displayed on the screen of the user device. The user interface 600 may include details of each sub-budget allocated to the corresponding task associated with the event.

The overall budget may be divided into multiple sub-budgets based on various parameters. For example, the overall budget of construction of the building may be divided into a sub-budget associated with a design phase, a sub-budget associated with a pre-construction phase, a sub-budget associated with procurement phase, a sub-budget associated with a construction phase, and a sub-budget associated with a post-construction/closeout phase.

In an embodiment, the overall budget may be divided into multiple sub-budgets based on information related to a budget allocation for a relevant event similar to the event allocated to the vendor when the relevant event is previously accomplished. In another embodiment, the overall budget may be divided into multiple sub-budgets based on a requirement of the one or more tasks to be performed for completion of the event when the event is newly introduced by the vendee. In yet another embodiment, the overall budget may be divided into multiple sub-budgets based on at least one parameter associated with a location of the event and a type of the one or more tasks to be performed for completing the event when the event is associated with a new vendee.

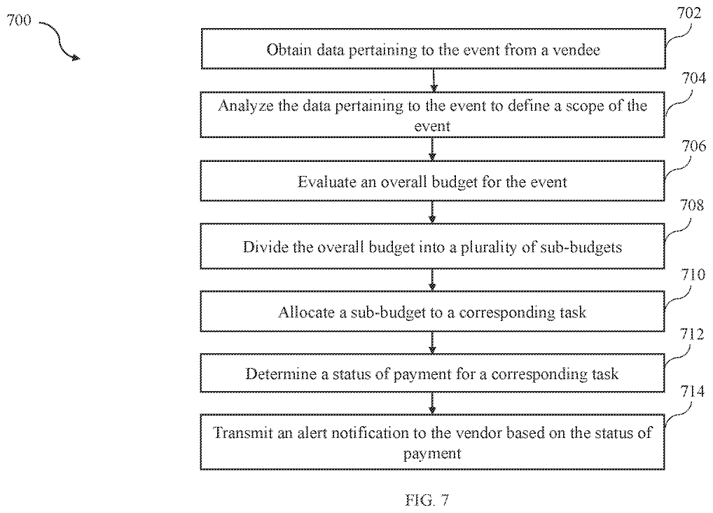

FIG. 7 illustrates a flow chart 700 of a method for managing asset allocation for the event, according to an embodiment of the present invention. The method starts with step 702. At step 702, the data processing engine obtains data pertaining to the event from the vendee. The event may be allocated to a vendor for completion of one or more tasks associated with the event. In some embodiments, the event is one of an operational event, a business event, a construction event, and a manufacturing event. The data pertaining to the event may comprise, but are not limited to, a start date of the event, a time period allotted to the event, constraints related to the event, and a difficulty level of the event.

At step 704, the data processing engine 102 may analyze the data pertaining to the event to define scope of the event. The scope of the event may indicate a time duration for completion of the one or more tasks associated with the event and a number of workers required for completion of the one or more tasks associated with the event.

At step 706, the data processing engine 102 may evaluate an overall budget for the event based on the scope of the event. The overall budget is an amount to be given to the vendor for completing the event. In some embodiments, the overall budget may be allotted by the vendee. In some other embodiments, the overall budget may be determined by the ML module 106 based on overall budget allotted for the relevant events.

At step 708, the ML module 106 may divide the overall budget into multiple sub-budgets. The overall budget may be divided into multiple sub-budgets based on various parameters. For example, the overall budget of construction of the building may be divided into a sub-budget associated with a design phase, a sub-budget associated with a pre-construction phase, a sub-budget associated with procurement phase, a sub-budget associated with a construction phase, and a sub-budget associated with a post-construction/closeout phase.

In an embodiment, the overall budget may be divided into multiple sub-budgets based on information related to a budget allocation for a relevant event similar to the event allocated to the vendor when the relevant event is previously accomplished. In another embodiment, the overall budget may be divided into multiple sub-budgets based on a requirement of the one or more tasks to be performed for completion of the event when the event is newly introduced by the vendee. In yet another embodiment, the overall budget may be divided into multiple sub-budgets based on at least one parameter associated with a location of the event and a type of the one or more tasks to be performed for completing the event when the event is associated with a new vendee.

At step 710, the ML module 106 may allocate a sub-budget from the plurality of sub-budgets to a corresponding task of the one or more tasks based on the division of the overall budget. For example, a first portion of the overall budget may be allocated a design phase, a second portion of the overall budget may be allocated to a pre-construction phase, a third portion of the overall budget may be allocated to a procurement phase, a fourth portion of the overall budget may be allocated to a construction phase, and a fifth portion of the overall budget may be allocated to a post-construction/closeout phase.

At step 712, the data processing engine 102 may determine a status of the payment for a corresponding task associated with the event. For example, the vendee may be required to make the payment for initialization of the event and a notification is sent to the device associated with the vendee related to make the payment upon completion of a task of the event. The data processing engine 102 may monitor whether the payment is processed for the corresponding task or not. If the payment is processed, the status of the corresponding task is marked as completed. On the contrary, if the payment is not processed, the status is marked as pending.

At step 714, the data processing engine 102 may transmit a notification to the vendor based on the status of the payment. For example, the vendor may be notified in order to determine whether the pending task is to be processed or not. In some embodiments, a concerned authority may also be notified regarding the status of the payment at the time of completion of a particular task of the event. In case the vendee has not made the payment, the data processing engine 102 may send a notification to the vendee for making the payment immediately or may report a problem which is considered by the concerned authority.

In some embodiments, if the vendee has not reported any complaint, the data processing engine 102 may transmit a notification to the particular employees working on the specific task related to not proceed further until the vendee makes the payment.

In some embodiments, the data processing engine 102 may notify the vendee and the concerned authority regarding completion of the event and may enable the vendee to provide feedback by entering inputs over a user interface installed over the device 110 associated with the vendee.

In some embodiments, the devices associated with the vendor may represent one of a variety of other computing devices (e.g., a laptop computer 104a, a smart phone 104b, a desktop computer 104c, an IP phone, a tablet, etc.) having hardware and software (e.g. web browser application) capable of processing and displaying information (e.g., web page, graphical user interface, etc.), and communicating information (e.g., web page request, user activity, campaign settings, etc.) over the network.

In some embodiments, the data processing engine 102 may notify the vendee regarding the multiple sub-events of the event and the portion of overall budget corresponding to the sub-event. The vendee may be required to make the payment for initialization of the event and a notification is sent to the device 110 associated with the vendee related to make the payment upon completion of a first sub-event of the event.

In some embodiments, the vendor may be enabled to real-time monitoring of the progression of the event through various notifications. In case the vendee wants to amend a particular sub-event of the event, the ML module accordingly may evaluate the change in cost of the particular sub-event of the event in accordance with amendment required by the vendee. Further, the data processing engine may notify the vendee regarding change in cost and also reallocate the phase wise budget.

In some embodiments, the data processing engine 102 may notify the vendee and the concerned authority regarding completion of the event and may enable the vendee to provide feedback by entering inputs over a user interface installed over the device 110 associated with the vendee.

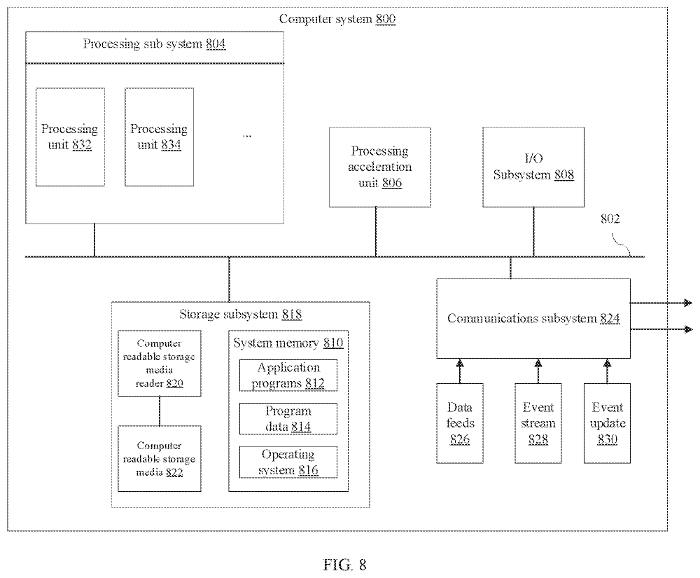

FIG. 8 illustrates a block diagram of an example computer system 800, according to an embodiment of the present invention. For example, in some embodiments, the computer system 800 may be used to implement any of systems, subsystems, and components described herein. For example, multiple host machines may provide and implement processes of a computing environment 100 as described herein. Computer systems such as computer system 800 may be used as host machines. As shown in FIG. 7, the computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. The storage subsystem 818 may include non-transitory computer-readable storage media including a computer-readable storage media 822 and a system memory 810.

Bus subsystem 802 provides a mechanism for letting the various components and subsystems of computer system 800 communicate with each other as intended. Although bus subsystem 802 is shown schematically as a single bus, alternative embodiments of the bus subsystem may utilize multiple buses. The subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of the computer system 800 and may comprise one or more processors, application specific integrated circuits (ASICs), or field programmable gate arrays (FPGAs). The processors may include be single core or multicore processors. The processing resources of the computer system 800 can be organized into one or more processing units 832, 834, etc. A processing unit may include one or more processors, one or more cores from the same or different processors, a combination of cores and processors, or other combinations of cores and processors. In some embodiments, processing subsystem 804 can include one or more special purpose co-processors such as graphics processors, digital signal processors (DSPs), or the like. In some embodiments, some or all of the processing units of processing subsystem 804 can be implemented using customized circuits, such as application specific integrated circuits (ASICs), or field programmable gate arrays (FPGAs).

In some embodiments, the processing units in processing subsystem 804 can execute instructions stored in system memory 810 or on the computer-readable storage media 822. In various embodiments, the processing units can execute a variety of programs or code instructions and can maintain multiple concurrently executing programs or processes. At any given time, some or all of the program code to be executed can be resident in system memory 810 and/or on the computer-readable storage media 822 including potentially on one or more storage devices. Through suitable programming, processing subsystem 804 can provide various functionalities described above. In instances where computer system 800 is executing one or more virtual machines, one or more processing units may be allocated to each virtual machine.

In certain embodiments, a processing acceleration unit 806 may optionally be provided for performing customized processing or for off-loading some of the processing performed by processing subsystem 804 so as to accelerate the overall processing performed by computer system 800.

The I/O subsystem 808 may include devices and mechanisms for inputting information to the computer system 800 and/or for outputting information from or via the computer system 800. In general, use of the term input device is intended to include all possible types of devices and mechanisms for inputting information to the computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

The storage subsystem 818 provides a repository or data store for storing information and data that is used by computer system 800. The storage subsystem 818 provides a tangible non-transitory computer-readable storage medium for storing the basic programming and data constructs that provide the functionality of some embodiments. The storage subsystem 818 may store software (e.g., programs, code modules, instructions) that when executed by processing subsystem 804 provides the functionality described above. The software may be executed by one or more processing units of processing subsystem 804. The storage subsystem 818 may also provide a repository for storing data used in accordance with the teachings of this disclosure.

The storage subsystem 818 may include one or more non-transitory memory devices, including volatile and non-volatile memory devices. The storage subsystem 818 is shown to be depicting, the system memory 810 and the computer-readable storage media 822, in FIG. 7. The system memory 810 may include a number of memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within the computer system 800, such as during start-up, may typically be stored in the ROM. The RAM typically contains data and/or program modules that are presently being operated and executed by processing subsystem 804. In some implementations, system memory 810 may include multiple different types of memory, such as static random-access memory (SRAM), dynamic random-access memory (DRAM), and the like.

By way of example, and not limitation, as depicted in FIG. 7, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

In certain embodiments, software instructions or code implementing the computing environment 100, as described herein, may be executed in system memory 810.

Computer-readable storage media 822 may store programming and data constructs that provide the functionality of some embodiments. Computer-readable storage media 822 may provide storage of computer-readable instructions, data structures, program modules, and other data for computer system 800. Software (programs, code modules, instructions) that, when executed by processing subsystem 804 provides the functionality described above, may be stored in the storage subsystem 818. By way of example, computer-readable storage media 822 may include non-volatile memory such as a hard disk drive, a magnetic disk drive, an optical disk drive such as a CD ROM, DVD, a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs.

In certain embodiments, the storage subsystem 818 may also include a computer-readable storage media reader 820 that can further be connected to computer-readable storage media 822. Reader 820 may receive and be configured to read data from a memory device such as a disk, a flash drive, etc.

In certain embodiments, computer system 800 may support virtualization technologies, including but not limited to virtualization of processing and memory resources. For example, computer system 800 may provide support for executing one or more virtual machines. In certain embodiments, computer system 800 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices.

Communication subsystem 824 may support both wired and/or wireless communication protocols. For example, in certain embodiments, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments communications subsystem 824 can provide wired network connectivity (e.g., Ethernet) in addition to or instead of a wireless interface.

Communication subsystem 824 can receive and transmit data in various forms. For example, in some embodiments, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain embodiments, the communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

The communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

The computer system 800 can be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 800 depicted in FIG. 7 is intended only as a specific example. Many other configurations having more or fewer components than the system depicted in FIG. 7 are possible. Based on the disclosure and teachings provided herein, a person of ordinary skill in the art will appreciate other ways and/or methods to implement the various embodiments.

The embodiments disclosed herein can be implemented through at least one software program running on at least one hardware device and performing network management functions to control the elements. The elements shown in FIG. 7 include blocks which can be at least one of a hardware device, or a combination of hardware device and software module.

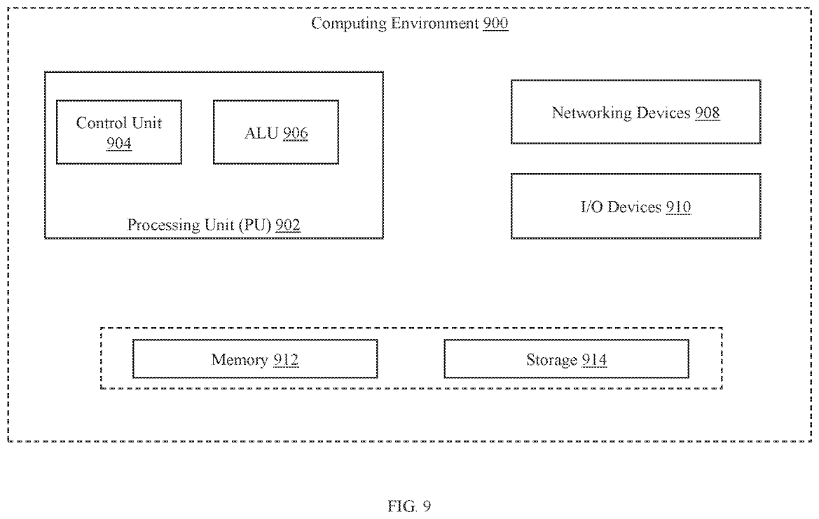

FIG. 9 illustrates an example computing environment implementing a system for managing asset allocation for the event, according to an embodiment of the present invention. As depicted in FIG. 9, the computing environment 900 (similar to the computing environment 100) comprises at least one processing unit 802 that is equipped with a control unit 904 and an Arithmetic Logic Unit (ALU) 906, a plurality of networking devices 908 and a plurality Input output, I/O devices 910, a memory 912, and a storage 914. The processing unit 902 may be responsible for implementing the method described in FIG. 7. For example, the processing unit 902 may in some embodiments be equivalent to the processor of the computing environment 100 described above in conjunction with the FIGS. 1-7. The processing unit 902 is capable of executing software instructions stored in memory 912. The processing unit 902 receives commands from the control unit 904 in order to perform its processing. Further, any logical and arithmetic operations involved in the execution of the instructions are computed with the help of the ALU 906.

The computer program is loadable into the processing unit 902, which may, for example, be comprised in an electronic apparatus. When loaded into the processing unit 902, the computer program may be stored in the memory 912 associated with or comprised in the processing unit 902. According to some embodiments, the computer program may, when loaded into and run by the processing unit 902, cause execution of method steps according to, for example, any of the methods illustrated in FIG. 7 or otherwise described herein.

The overall computing environment 900 may be composed of multiple homogeneous and/or heterogeneous cores, multiple CPUs of different kinds, special media and other accelerators. Further, the plurality of processing unit 902 may be located on a single chip or over multiple chips.

The algorithm comprising of instructions and codes required for the implementation are stored in either the memory 912 or the storage or both. At the time of execution, the instructions may be fetched from the corresponding memory 912 and/or storage, and executed by the processing unit 902.

In case of any hardware implementations various networking devices 908 or external I/O devices 910 may be connected to the computing environment to support the implementation through the networking devices 908 and the I/O devices 910.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user's computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer-readable media such as RAMs, ROMs, flash memory, EEPROMs, optical devices (CD or DVD), hard drives, and floppy drives, or any suitable device. The computer-executable component can be a processor but any suitable dedicated hardware device can (alternatively or additionally) execute the instructions.

As a person skilled in the art will recognize from the previous detailed description and the figures and claims, modifications and changes can be made to the embodiments of the invention without departing from the spirit and scope of this invention.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible.

What is claimed is:

1. A method for managing budget allocation for an event, comprising:
acquiring, by a data processing engine, data pertaining to the event from a first terminal device of a plurality of terminal devices associated with a vendee of a plurality of vendees, wherein
the event is allocated to a vendor of a plurality of vendors for completion of one or more tasks associated with the event,
the data processing engine is communicatively coupled to a machine learning (ML) model, a server, a communication module, and the plurality of terminal devices that is associated to the plurality of vendors, the plurality of vendees, and an authority, and
the ML model is trained for the budget allocation, via a supervised learning process, based on training data, wherein the supervised learning process comprises:
receiving, by the ML model, the training data, for evaluation from the server, wherein the training data comprises pre-identified data and unidentified data;
segregating, by the data processing engine, the training data to at least one of content tags, content objects, and user metadata, wherein the content tags correspond to unidentified data of the training data, the content objects and the user metadata correspond to the pre-identified data of the training data, and the user metadata corresponds to metadata related to the plurality of vendors and the plurality of vendees;
evaluating, invariably, by a propensity calculator of the ML model, the unidentified data for identifying the content tags, based on the pre-identified data;
executing, by an error-minimization module of the ML model, an objective function to compute a degree of error in identifying the content tags, wherein the propensity calculator outputs data, the error-minimization module receives the output data from the propensity calculator and the training data for executing the objective function, and the error-minimization module outputs information related to the degree of error to the propensity calculator as feedback; and
changing, invariably, by the ML model, at least a coefficient of the propensity calculator till the degree of error in identifying the content tags recede a value, wherein the changing of the at least the coefficient of the propensity calculator is based on the feedback from the error-minimization module, and the value is based on the changing of the at least the coefficient of the propensity calculator to minimize the degree of error;
optimizing, by the trained ML model, the trained ML model, in addition to the supervised learning process, by implementing a machine-readable set of instructions that corresponds to hyperparametric tuning;
analyzing, by the trained ML model, the data pertaining to the event to identify a plurality of parameters associated to the event including at least one of a time duration for completion of each task of the one or more tasks associated with the event, cost of raw materials utilized in the event, an insurance related to the event, or a number of workers required for completion of the one or more tasks associated with the event;
segregating, by the data processing engine, the event into multiple sub-events based on identification of the plurality of parameters;
evaluating, by the trained ML model, an overall budget for the event based on the segregating of the event and the identification of the plurality of parameters;
segregating, by the trained ML model, the overall budget into a plurality of sub-budgets based on the evaluating of the overall budget and at least one of:
data related to a budget allocation for a relevant event similar to the event allocated to the vendor when the relevant event is previously accomplished, wherein the ML model is communicatively coupled to the server that stores data related to a plurality of events, the trained ML model verifies similarity between the event allocated to the vendor and a first event of the plurality of events by mapping the data of the event allocated to the vendor and the data of the plurality of events, the trained ML model identifies the relevant event when the data of the event allocated to the vendor matches with the data of the first event,
a requirement of the one or more tasks to be performed for completion of the event when the event is newly introduced by the vendee, or; and
at least one parameter associated with a location of the event, a location of the vendee, and a type of the one or more tasks to be performed for completing the event when the event is associated with a new vendee;
allocating, by the trained ML model, a sub-budget from the plurality of sub-budgets to a corresponding task of the one or more tasks based on the segregating of the overall budget into the plurality of sub-budgets for multiple sub-events;
determining, subsequent to the allocating of the sub-budget, by the data processing engine, in real-time, whether a notification, is received, indicating a requirement to make changes in at least one task of the one or more tasks associated with the event;
estimating, by the trained ML model, in real-time, a change in the sub-budget allocated for a corresponding task associated with the event based on a degree of change in the corresponding task and reception of the notification indicating the requirement to make changes;
reallocating, by the trained ML model, the sub-budget to the corresponding task, based on the estimating the change in the sub-budget;
transmitting a first notification, by the communication module, to the first terminal device associated with the vendee, wherein the first notification indicates a requirement of making a payment upon completion of the corresponding task;
monitoring, by the trained ML model, in real-time, a status of releasing the sub-budget for the corresponding task when the corresponding task is completed;
determining, by the trained ML model, whether the sub-budget is released by the vendee when the corresponding task is completed, based on the monitoring of the status; and
transmitting one of, a second notification, by the communication module, to the first terminal device that enables the vendee to provide feedback by entering inputs over a user interface installed over the first terminal device when the corresponding task is completed or a third notification, to at least a second terminal device of the plurality of terminal devices, associated with the vendor, at least indicating the vendor to stop operation of other tasks and a third terminal device of the plurality of terminal devices, associated with the authority, indicating a requirement to report a problem when payment of the sub-budget is determined as pending by the vendee, wherein
one of the second notification or the third notification is transmitted after transmission of the first notification.

2. The method according to claim 1, wherein the event is one of an operational event, a business event, a construction event, and a manufacturing event.

3. The method according to claim 1, wherein the data pertaining to the event comprises at least one of a start date of the event, a time period allotted to the event, constraints related to the event, and a difficulty level of the event.

4. (canceled)

5. The method according to claim 1, further comprising:
monitoring, by the ML model, progression of the event to determine completion of each task of the one or more tasks.

6. (canceled)

7. (canceled)

8. (canceled)

9. A system for managing budget allocation for an event, comprising:
a data processing engine;
a machine learning (ML) model;
a server configured to store data related to a plurality of events;
a plurality of terminal devices associated to a plurality of vendors, a plurality of vendees, and an authority, wherein the data processing engine is communicatively coupled to each of the ML model, the server, and the plurality of terminal devices, and the data processing engine is configured to:
acquire data pertaining to the event from a first terminal device of the plurality of terminal devices associated with a vendee of the plurality of vendees, wherein
the event is allocated to a vendor of the plurality of vendors for completion of one or more tasks associated with the event;
execute a supervised learning process for training the ML model for the budget allocation, wherein the supervised learning process comprises:
receiving, by the ML model, the training data, for evaluation from the server, wherein the training data comprises pre-identified data and unidentified data;
segregating, by the data processing engine, the training data to at least one of content tags, content objects, and user metadata, wherein the content tags correspond to unidentified data of the training data, the content objects and the user metadata correspond to the pre-identified data of the training data, and the user metadata corresponds to metadata related to the plurality of vendors and the plurality of vendees;
evaluating, invariably, by a propensity calculator of the ML model, the unidentified data for identifying the content tags, based on the pre-identified data;
executing, by an error-minimization module of the ML model, an objective function to compute a degree of error in identifying the content tags, wherein the propensity calculator outputs data, the error-minimization module receives the output data from the propensity calculator and the training data for executing the objective function, and the error-minimization module outputs information related to the degree of error to the propensity calculator as feedback; and
changing, invariably, by the ML model, at least a coefficient of the propensity calculator till the degree of error in identifying the content tags recede a value, wherein the changing of the at least the coefficient of the propensity calculator is based on the feedback from the error-minimization module, and the value is based on the changing of the at least the coefficient of the propensity calculator to minimize the degree of error;
control the trained ML model to optimize, in addition to the supervised learning process, by implementing a machine-readable set of instructions that corresponds to hyperparametric tuning;
control the trained ML model to analyze the data pertaining to the event to identify a plurality of parameters associated to the event including at least one of a time duration for completion of each task of the one or more tasks associated with the event, cost of raw materials utilized in the event, an insurance related to the event, or a number of workers required for completion of the one or more tasks associated with the event;
segregate the event into multiple sub-events based on identification of the plurality of parameters;
control the trained ML model to evaluate an overall budget for the event based on segregation of the event and the identification of the plurality of parameters;
control the trained ML model to segregate the overall budget into a plurality of sub-budgets based on evaluation of the overall budget and at least one of:
data related to a budget allocation for a relevant event similar to the event allocated to the vendor when the relevant event is previously accomplished, wherein the trained ML model verifies similarity between the event allocated to the vendor and a first event of the plurality of events stored in the server by mapping the data of the event allocated to the vendor and the data of the plurality of events, the trained ML model identifies the relevant event when the data of the event allocated to the vendor matches with the data of the first event,
a requirement of the one or more tasks to be performed for completion of the event when the event is newly introduced by the vendee, or; and
at least one parameter associated with a location of the event, a location of the vendee, and a type of the one or more tasks to be performed for completing the event when the event is associated with a new vendee;
control the trained ML model to allocate a sub-budget of the plurality of sub-budgets to a corresponding task of the one or more tasks based on segregation of the overall budget into the plurality of sub-budgets for multiple sub-events;
determine, subsequent to the allocating of the sub-budget, in real-time, whether a notification, is received, indicating a requirement to make changes in at least one task of the one or more tasks associated with the event;
control the trained ML model to estimate, in real-time, a change in the sub-budget allocated for a corresponding task associated with the event based on a degree of change in the corresponding task and reception of the notification indicating the requirement to make changes;
control the trained ML model to reallocate the sub-budget to the corresponding task, based on estimation of the change in the sub-budget;
transmit a first notification, via a communication module, to the first terminal device associated with the vendee, wherein the first notification indicates a requirement of making a payment upon completion of the corresponding task;
control the trained ML model to monitor, in real-time, a status of releasing the sub-budget for the corresponding task when the corresponding task is completed;
control the trained ML model to determine whether the sub-budget is released by the vendee when the corresponding task is completed, based on monitoring of the status; and
transmit one of, a second notification, via the communication module, to the first terminal device that enables the vendee to provide feedback by entering inputs over a user interface installed over the first terminal device of when the corresponding task is completed or a third notification, to at least a second terminal device of the plurality of terminal devices, associated with the vendor, at least indicating the vendor to stop operation of other tasks and a third terminal device of the plurality of terminal devices, associated with the authority, indicating a requirement to report a problem when payment of the sub-budget is determined as pending by the vendee, wherein
one of the second notification or the third notification is transmitted after transmission of the first notification.

10. The system according to claim 9, wherein the event is one of an operational event, a business event, a construction event, and a manufacturing event.

11. The system according to claim 9, wherein the data pertaining to the event comprises at least one of a start date of the event, a time period allotted to the event, constraints related to the event, and a difficulty level of the event.

12. (canceled)

13. The system according to claim 9, wherein the data processing engine is further configured to:
control the ML model to monitor progression of the event to determine completion of each task of the one or more tasks.

14. (canceled)

15. (canceled)

16. (canceled)

17. A non-transitory computer readable medium for managing budget allocation for an event having stored thereon computer-executable instructions that, when executed by a data processing engine, cause the data processing engine to execute operations, the operations comprising:
acquiring data pertaining to the event from a first terminal device of a plurality of terminal devices associated with a vendee of a plurality of vendees, wherein the event is allocated to a vendor of a plurality of vendors for completion of one or more tasks associated with the event, the data processing engine is communicatively coupled to each of a machine learning (ML) model, a server, a communication module, and the plurality of terminal devices, and the plurality of terminal devices is associated to the plurality of vendors, the plurality of vendees, and an authority;
executing a supervised learning process for training the ML model for the budget allocation, wherein the supervised learning process comprises:
receiving, by the ML model, the training data, for evaluation from the server, wherein the training data comprises pre-identified data and unidentified data;
segregating, by the data processing engine, the training data to at least one of content tags, content objects, and user metadata, wherein the content tags correspond to unidentified data of the training data, the content objects and the user metadata correspond to the pre-identified data of the training data, and the user metadata corresponds to metadata related to the plurality of vendors and the plurality of vendees;
evaluating, invariably, by a propensity calculator of the ML model, the unidentified data for identifying the content tags, based on the pre-identified data;
executing, by an error-minimization module of the ML model, an objective function to compute a degree of error in identifying the content tags, wherein the propensity calculator outputs data, the error-minimization module receives the output data from the propensity calculator and the training data for executing the objective function, and the error-minimization module outputs information related to the degree of error to the propensity calculator as feedback; and
changing, invariably, by the ML model, at least a coefficient of the propensity calculator till the degree of error in identifying the content tags recede a value, wherein the changing of the at least the coefficient of the propensity calculator is based on the feedback from the error-minimization module, and the value is based on the changing of the at least the coefficient of the propensity calculator to minimize the degree of error;
controlling the trained ML model to optimize, in addition to the supervised learning process, by implementing a machine-readable set of instructions that corresponds to hyperparametric tuning;
controlling the trained ML model to analyze the data pertaining to the event to identify a plurality of parameters associated to the event including at least one of a time duration for completion of each task of the one or more tasks associated with the event, cost of raw materials utilized in the event, an insurance related to the event, or a number of workers required for completion of the one or more tasks associated with the event;
segregating the event into multiple sub-events based on identification of the plurality of parameters;
controlling the trained ML model to evaluate an overall budget for the event based on the segregating of the event and the identification of the plurality of parameters;
controlling the trained ML model to segregate divide, by the ML module, the overall budget into a plurality of sub-budgets based on evaluation of the overall budget and at least one of:
data related to a budget allocation for a relevant event similar to the event allocated to the vendor when the relevant event is previously accomplished, wherein the trained ML model verifies similarity between the event allocated to the vendor and a first event of the plurality of events stored in the server by mapping the data of the event allocated to the vendor and the data of the plurality of events, the trained ML model identifies the relevant event when the data of the event allocated to the vendor matches with the data of the first event,
a requirement of the one or more tasks to be performed for completion of the event when the event is newly introduced by the vendee, or; and
at least one parameter associated with a location of the event, a location of the vendee, and a type of the one or more tasks to be performed for completing the event when the event is associated with a new vendee;
controlling the trained ML model to allocate a sub-budget of the plurality of sub-budgets to a corresponding task of the one or more tasks based on segregation of the overall budget into the plurality of sub-budgets for multiple sub-events;
determining, subsequent to the allocating of the sub-budget, in real-time, whether a notification, is received, indicating a requirement to make changes in at least one task of the one or more tasks associated with the event;
controlling the trained ML model to estimate, in real-time, a change in the sub-budget allocated for a corresponding task associated with the event based on a degree of change in the corresponding task and reception of the notification indicating the requirement to make changes;
controlling the trained ML model to reallocate the sub-budget to the corresponding task, based on estimation of the change in the sub-budget;
transmitting a first notification, via the communication module to the first terminal device associated with the vendee, wherein the first notification indicates a requirement of making a payment upon completion of the corresponding task;
controlling the trained ML model to monitor, in real-time, a status of releasing the sub-budget for the corresponding task when the corresponding task is completed;
controlling the trained ML model to determine whether the sub-budget is released by the vendee when the corresponding task is completed, based on monitoring of the status; and
transmitting one of, a second notification, via the communication module, to the first terminal device that enables the vendee to provide feedback by entering inputs over a user interface installed over the first terminal device when the corresponding task is completed or a third notification, to at least a second terminal device of the plurality of terminal devices, associated with the vendor, at least indicating the vendor to stop operation of other tasks and a third terminal device of the plurality of terminal devices, associated with the authority, indicating a requirement to report a problem when payment of the sub-budget is determined as pending by the vendee, wherein
one of the second notification or the third notification is transmitted after transmission of the first notification.

18. The non-transitory computer readable medium according to claim 17, wherein the event is one of an operational event, a business event, a construction event, and a manufacturing event.

19. The non-transitory computer-readable medium according to claim 17, wherein the data pertaining to the event comprises at least one of a start date of the event, a time period allotted to the event, constraints related to the event, and a difficulty level of the event.

20. (canceled)
